(19) United States
(12) Patent Application Publication
(10) Pub. No.: US 2025/0371058 A1
(43) Pub. Date: Dec. 4, 2025

(54) METHOD OF PROVIDING SEARCH RESULTS BASED ON USER'S SEARCH CONTEXT AND USER DEVICE USING THE METHOD

(71) Applicant: Samsung Electronics Co., Ltd., Suwon-si (KR)

(72) Inventors: Sungmok SEO, Suwon-si (KR); Junghwan LEE, Suwon-si (KR); Seunggyu KONG, Suwon-si (KR); Sejeong KWON, Suwon-si (KR); Sungwon KIM, Suwon-si (KR); Taehun KIM, Suwon-si (KR); Yunsu LEE, Suwon-si (KR); Myunghee HAN, Suwon-si (KR)

(21) Appl. No.: 19/219,534

(22) Filed: May 27, 2025

Related U.S. Application Data
(63) Continuation of application No. PCT/KR2025/005818, filed on Apr. 29, 2025.

(30) Foreign Application Priority Data
May 28, 2024 (KR) 10-2024-0069519

(51) Int. Cl. G06F 16/335; G06F 9/50; G06F 16/35

(52) U.S. Cl. CPC G06F 16/335; G06F 9/5027; G06F 16/35

(57) ABSTRACT

A method of providing search results based on a user's search context is provided. The method includes determining a user's search context based on a user input and context information for a search, determining a tolerance limit representing a degree to which a user is tolerable from the determined user's search context, obtaining a search condition for the search, based on the determined tolerance limit, and providing search results according to the obtained search condition.

### CROSS-REFERENCE TO RELATED APPLICATION(S)

This application is a continuation application, claiming priority under 35 U.S.C. § 365 (c), of an International application No. PCT/KR2025/005818, filed on Apr. 29, 2025, which is based on and claims the benefit of a Korean patent application number 10-2024-0069519, filed on May 28, 2024, in the Korean Intellectual Property Office, in the Korean Intellectual Property Office, the disclosure of which is incorporated by reference herein in its entirety.

### TECHNICAL FIELD

The disclosure relates to a method of providing search results based on a user's search context and a user device using the method.

### BACKGROUND ART

Artificial intelligence (AI)-based technologies have been utilized in various fields across industries. Various AI models have been developed and utilized in various fields. Cases where AI-based solutions are applied to various industries, including manufacturing, robotics, transportation/logistics, medical treatment, education, or pharmaceutical/bio industries, are rapidly increasing. The introduction of such AI-based technologies leads to enhanced competitiveness for companies and countries.

To improve the performance of AI models, a knowledge base for AI model learning and AI model inference may be used. An example of the knowledge base is a knowledge graph that has a graph-type data structure. Interest in constructing and utilizing knowledge graphs is increasing.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an embodiment of the disclosure is to provide a method of providing search results based on user's search context and user device using the method.

An embodiment of the disclosure will be set forth in part in the description which follows and, in part, will be apparent from the description, or may be learned by practice of the presented embodiments.

In accordance with an embodiment of the disclosure, a method of providing search results based on a user's search context is provided. The method includes determining a user's search context based on a user input for a search and context information, determining a tolerance limit representing a degree to which a user is tolerable from the determined user's search context, obtaining a search condition for the search, based on the determined tolerance limit, and providing search results according to the obtained search condition.

In accordance with an embodiment of the disclosure, one or more non-transitory computer-readable storage media storing one or more computer programs including computer-executable instructions that, when executed by one or more processors of an electronic device individually or collectively, cause the electronic device to perform operations is provided. The operations include determining a user's search context based on a user input for a search and context information, determining a tolerance limit representing a degree to which a user is tolerable from the determined user's search context, obtaining a search condition for the search, based on the determined tolerance limit, and providing search results according to the obtained search condition.

In accordance with an embodiment of the disclosure, a user device for providing search results based on a user's search context is provided. The user device includes memory including one or more storage media storing one or more computer programs, and at least one processor communicatively coupled to the memory, wherein the one or more computer programs include computer-executable instructions that, when executed by the one or more processors individually or collectively, cause the user device to execute the at least one instruction to determine a user's search context based on a user input for a search and context information, determine a tolerance limit representing a degree to which a user is tolerable from the determined user's search context, obtain a search condition for the search, based on the determined tolerance limit, and execute the at least one instruction to provide search results according to the obtained search condition.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an artificial intelligence (AI) platform based on a personal knowledge graph, according to an embodiment of the disclosure;

FIG. 2 is a diagram illustrating an operation performed by a user device to construct a knowledge graph-based personalized database, according to an embodiment of the disclosure;

FIGS. 3A and 3B are diagrams illustrating a portion of a content ontology as an example of ontology used by a user device to construct a personal knowledge graph, according to an embodiment of the disclosure;

FIG. 4 is a diagram illustrating an operation performed by a user device to provide a personal knowledge graph-based service to a user, according to an embodiment of the disclosure;

FIGS. 5A, 5B, and 5C are diagrams illustrating a process performed by a user device to search for a photo by using a search term based on knowledge property information through a personal knowledge graph-based search application, according to an embodiment of the disclosure;

FIGS. 6A and 6B are diagrams illustrating a comparison of states in which a user device provides different search results for the same search term according to an embodiment of the disclosure;

FIG. 7 is a flowchart illustrating a method of providing search results based on a user's search context, according to an embodiment of the disclosure;

FIG. 8 is a diagram illustrating a process of determining a user's search context based on a user input and context information, according to an embodiment of the disclosure;

FIG. 9 is a diagram illustrating a process of determining a tolerance limit from a user's search context, according to an embodiment of the disclosure;

FIG. 10 is a diagram illustrating an example of a query condition affecting a search time, according to an embodiment of the disclosure;

FIG. 11 is a detailed flowchart illustrating a process of providing search results, according to an embodiment of the disclosure;

FIG. 12 is a block diagram illustrating a user device according to an embodiment of the disclosure; and

FIG. 13 is a block diagram illustrating a configuration and an operation of a user device according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms as used herein are briefly described and the disclosure is described in detail. Throughout the disclosure, the expression “at least one of a, b or c” indicates only a, only b, only c, both a and b, both a and c, both b and c, all of a, b, and c, or variations thereof.

As for the terms as used in the disclosure, common terms that are currently widely used are selected as much as possible while taking into account the functions in the disclosure. However, the terms may vary depending on the intention of those of ordinary skill in the art, precedents, the emergence of new technology, and the like. Also, in a particular case, there are also terms arbitrarily selected by the applicant. In this case, the meaning of the terms will be described in detail in the description of the disclosure. Therefore, the terms as used herein should be defined based on the meaning of the terms and the description throughout the disclosure rather than simply the names of the terms.

All terms including technical or scientific terms as used herein have the same meaning as commonly understood by those of ordinary skill in the art. It will be understood that although the terms “first,” “second,” etc. may be used to describe various elements, these elements should not be limited by these terms. These terms are only used to distinguish one element from another.

Throughout the specification, the expression “a portion includes a certain element” means that the portion may further include other elements rather than excludes other elements unless otherwise stated. Also, the terms such as “unit” and “module” described in the specification mean units that process at least one function or operation, and may be implemented as hardware, software, or a combination of hardware and software.

The functions related to artificial intelligence (AI) according to the disclosure are operated through a processor and memory. The processor may be implemented as one or more processors. At this time, the one or more processors may be a general-purpose processor, such as a central processing unit (CPU), an application processor (AP), or a digital signal processor (DSP), a dedicated graphics processor, such as a graphics processing unit (GPU) or a vision processing unit (VPU), or a dedicated AI processor, such as a neural processing unit (NPU). The one or more processors may perform control to process input data according to an AI model or a predefined operation rule stored in the memory. Alternatively, when the one or more processors are dedicated AI processors, the dedicated AI processors may be designed with a hardware structure specialized for processing a specific AI model.

The AI model and the predefined operation rule are made through learning. The expression “being made through learning” means that the AI model or the predefined operation rule configured to perform desired characteristics (or purposes) is made in such a manner that a basic AI model is trained by using a large number of training data by a learning algorithm. The learning may be accomplished in a device itself that performs AI according to the disclosure, or may be accomplished through a separate server and/or system. Examples of the learning algorithm include supervised learning, unsupervised learning, semi-supervised learning, or reinforcement learning, but the disclosure is not limited to the examples described above.

The AI model may include a plurality of neural network layers. Each of the neural network layers has a plurality of weight values and performs neural network operations through operations between the plurality of weight values and an operation result of a previous layer. The weight values of the neural network layers may be optimized by a training result of the AI model. For example, the weight values may be updated so that a loss value or a cost value obtained by the AI model during a training process is reduced or minimized. An artificial neural network may include a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks, etc., but the disclosure is not limited to the examples described above.

In the disclosure, a “knowledge graph” is a method of managing and searching for knowledge information and refers to a graph-structured knowledge base based on a knowledge base that stores knowledge information and a graph that expresses knowledge information so as to be analyzed in a network structure. The knowledge graph is a graph model that implements knowledge accumulated in the knowledge base as a relationship between nodes and edges. The knowledge graph may be used to integrate data by using graph data models, topologies, etc. To enable knowledge to be interconnected and integrated by using a knowledge graph, a schema is implemented through ontology, and a structure and dictionary (terminology) that may be shared with each other are used.

Semantic information including commonsense and fact knowledge is organized as connections between nodes and edges, and various types of data may be converted into the form of a knowledge graph with reference to the semantic information. As a method of expressing a knowledge graph, a labeled property graph (LPG) in which a node and an edge each have properties, a resource description framework (RDF) that expresses a relationship in a triple structure of subject-predicate-object, etc. may be used, but the disclosure is not limited thereto. The knowledge graph may be generated by recognizing entities from various data, performing linking (entity linking) to appropriate entities in an existing knowledge base, and extracting a relationship between the entities.

The knowledge graph may be used to improve the performance of AI. The knowledge graph may be used in models, such as a graph neural network (GNN) or a graph convolution neural network (GCN), and may be used to provide a description of a result in explainable AI (XAI).

Hereinafter, an embodiment of the disclosure will be described in detail with reference to the accompanying drawings, so that those of ordinary skill in the art may easily carry out the disclosure. However, the disclosure may be implemented in various different forms and is not limited to the embodiment of the disclosure described herein.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, the disclosure is described in detail with reference to the accompanying drawings.

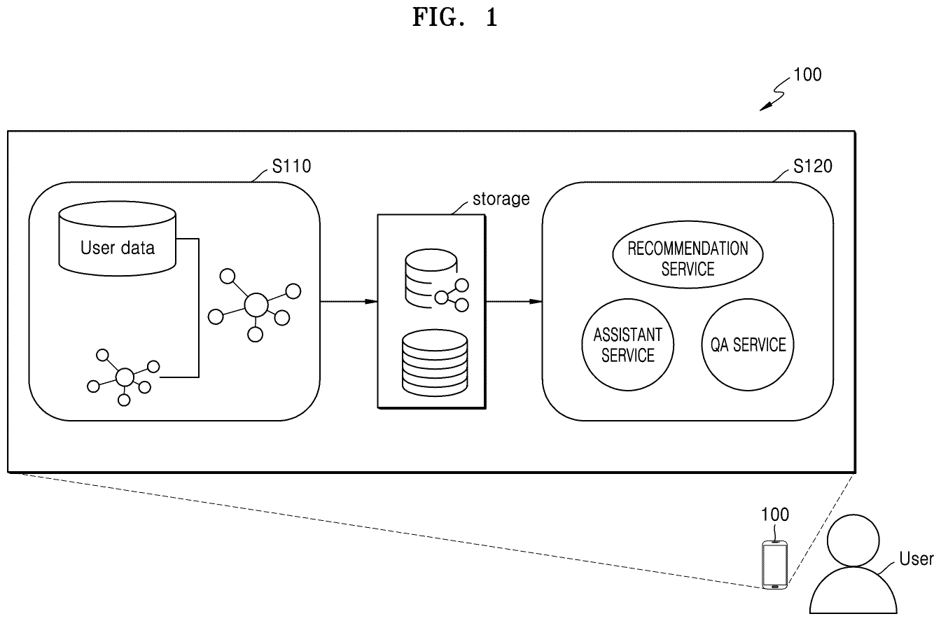

FIG. 1 is a diagram illustrating an AI platform based on a personal knowledge graph, according to an embodiment of the disclosure.

Referring to FIG. 1, the AI platform based on the personal knowledge graph is provided to a user by a process of constructing a knowledge graph-based personalized database (S110) and a process of providing a personalized AI service to a user through a knowledge graph-based service application (S120).

In the process of constructing the knowledge graph-based personalized database (S110), a user device 100 may generate a personal knowledge graph of a standardized form with reference to a general knowledge graph of a standardized form, such as commonsense and fact knowledge, by using user data obtained by the user device 100. The user device 100 may convert various types of unstructured data into the form of a knowledge graph, construct a knowledge graph-based personalized database, i.e., a personal knowledge graph, and store the personal knowledge graph in a storage.

In the process of providing the personalized AI service to the user through the knowledge graph-based service application (S120), the user device 100 may provide various services by using the personalized database stored in the storage, i.e., the personal knowledge graph. The user device 100 may provide a recommendation service, an assistant service, a question answering (QA) service, etc. by using the personal knowledge graph.

For example, when an action is performed by the user, the user device 100 may use the recommendation service to recommend music that the user enjoys listening to while performing the action or may use the assistant service to provide knowledge information based on the personal knowledge graph as well as information about related past experiences or upcoming events (e.g., calendar schedules). The user device 100 may identify a user's behavioral pattern from the personalized database, and when the user exhibits a pattern that is different from a usual behavioral pattern, the user device 100 may use the recommendation service to provide a solution service related to the cause of the different pattern. The user device 100 may use the QA service to provide a customized answer to a user's question, based on the personalized database. The user device 100 may use the assistant service to perform a journaling function to manage and describe a user's daily work or special event, etc. by using the personalized database.

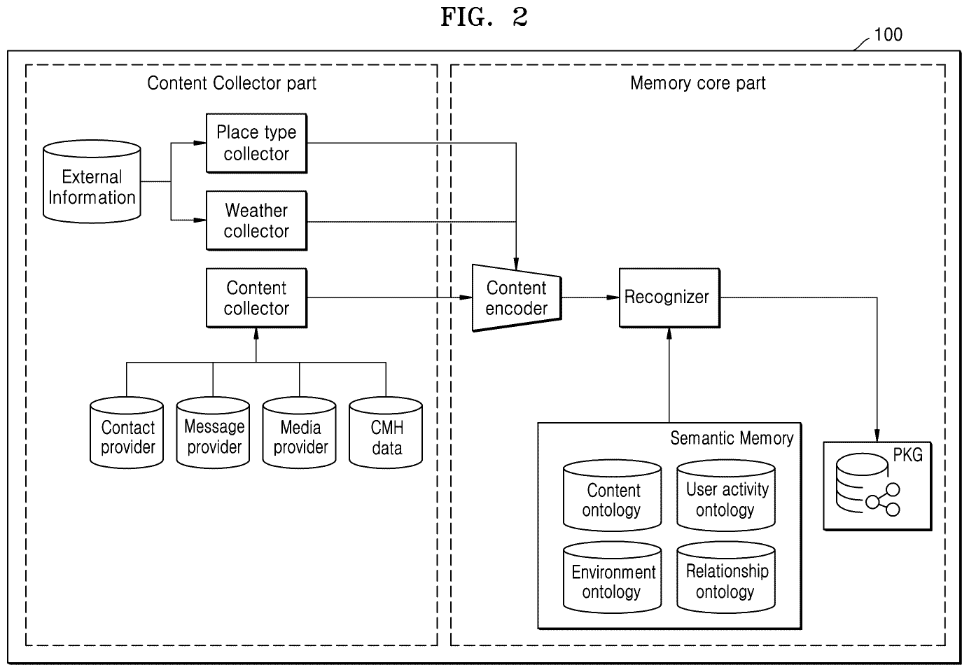

FIG. 2 is a diagram illustrating an operation performed by the user device 100 to construct a knowledge graph-based personalized database, according to an embodiment of the disclosure.

Referring to FIG. 2, the user device 100 may be an electronic device capable of processing data. For example, the user device 100 may be an electronic device, such as a smartphone, smart glasses, a wearable device, a digital camera, a laptop, an augmented reality (AR) device, or a virtual reality (VR) device. Various types of neural network models may be mounted on the user device 100. For example, at least one of models, such as a CNN, a GCN, a GNN, a DNN, an RNN, or a BRDNN, may be mounted on the user device 100, and a combination thereof may be used.

The user device 100 may convert various types of unstructured data into the form of a knowledge graph and construct a knowledge graph-based personalized database. The user device 100 may obtain various types of data and convert the data into triple format data. The user device 100 may map the converted data to ontology stored in semantic memory and reflect standardized information matching the ontology format to the personal knowledge graph. The ontology is a type of dictionary that defines terms conceptualizing data and a relationship between the terms. The ontology may be expanded by converting external knowledge into triple format data and adding the triple format data.

The data obtained by the user device 100 may be metadata for content, such as text, photos, videos, or music, which is collected by the user device 100. The data obtained by the user device 100 may be those stored in the user device 100 in the form of metadata about the application used or metadata about event occurrence time, place, weather, etc. The data obtained by the user device 100 may include at least one of data input from the user through the user device 100, data sensed by the user device 100, external data received by the user device 100, or data processed by the user device 100.

The user device 100 may process unstructured data obtained by the user device 100 into structured information and store the structured information in the personal knowledge graph. The user device 100 may previously prepare semantic information of a standardized form in the semantic memory as ontology. By referring to semantic information of various types of ontologies stored in the semantic memory, the user device 100 may process unstructured data obtained by the user device 100 into structured information and store the structured information in the personalized database. For example, the user device 100 may convert various types of unstructured data into the form of a knowledge graph and store the knowledge graph in the personal knowledge graph.

FIG. 2 illustrates an example of a process performed by the user device 100 to collect metadata about content generated or provided by the user device 100 and construct a personalized database in the form of a knowledge graph. For detailed explanation, an example of a process of constructing a personal knowledge graph based on user content is described with reference to FIG. 2, but the disclosure is not limited thereto and may be applied to other types of personal knowledge graphs.

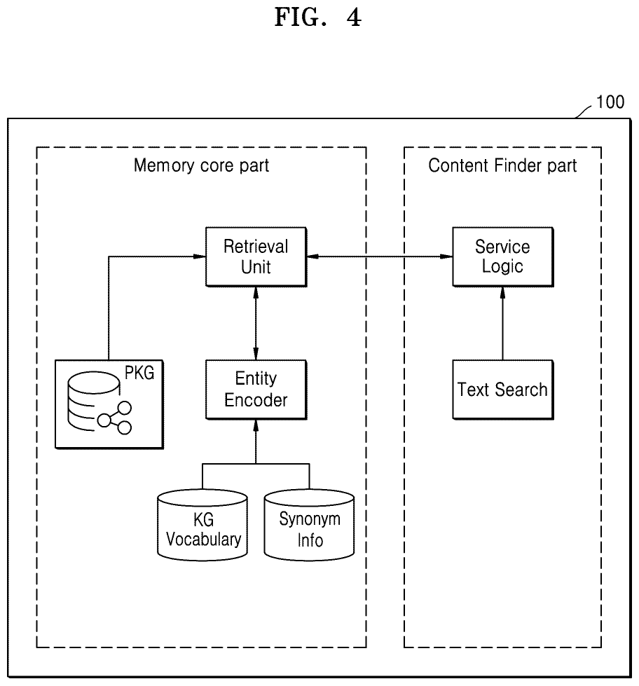

In the user device 100, a content collector of a content collector part may collect metadata about content from a contact provider, a message provider, a media provider, content management hub (CMH) data, etc. The content collector is not limited to the example illustrated in FIG. 4 and may collect metadata from various types of applications installed on the user device 100. The content collector may include a postprocessing module that classifies character types, parses text, classifies image types, and recognizes objects within images. A place type collector and a weather collector may collect metadata about a place or a weather from external information obtained by the user device 100.

In the user device 100, a content encoder of a memory core part may convert the metadata about the content and the metadata corresponding to the place or the weather related to the content into triple format data. A recognizer may map the triple format data to ontology stored in semantic memory, infer standardized information matching an ontology format, and reflect the inferred standardized information to the personal knowledge graph. As illustrated in FIG. 2, various types of ontologies, such as content ontology, user activity ontology, environment ontology, or relationship ontology, may be previously prepared in the semantic memory according to the purpose, and the recognizer may integrate various ontologies prepared in the semantic memory and perform a search.

Referring to FIG. 2, a process performed by the user device 100 to construct the personal knowledge graph based on user content by collecting metadata about content generated or provided by the user device 100, convert the collected metadata into a triple format, and then map the triple format metadata to the content ontology is illustrated as an example of constructing the knowledge graph-based personalized database. The personal knowledge graph based on the user content may use nodes and edges to represent instances of content collected by using photos or videos owned by the user, message information transmitted and received by the user, or contact information. For example, the message provider and the media provider may transmit, to the content encoder, card payment information received on January 1 and data about a photo taken on January 1, which are received by the user device 100. The transmitted data may be linked to the ontology of the personal knowledge graph as an instance of an event that occurred on January 1 through text and metadata analysis.

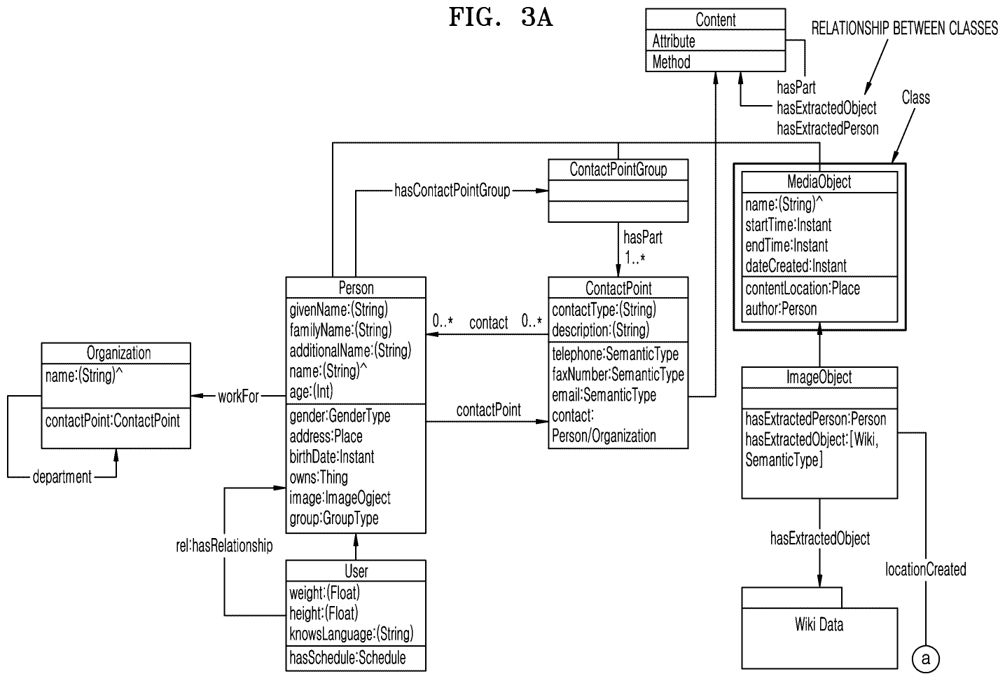

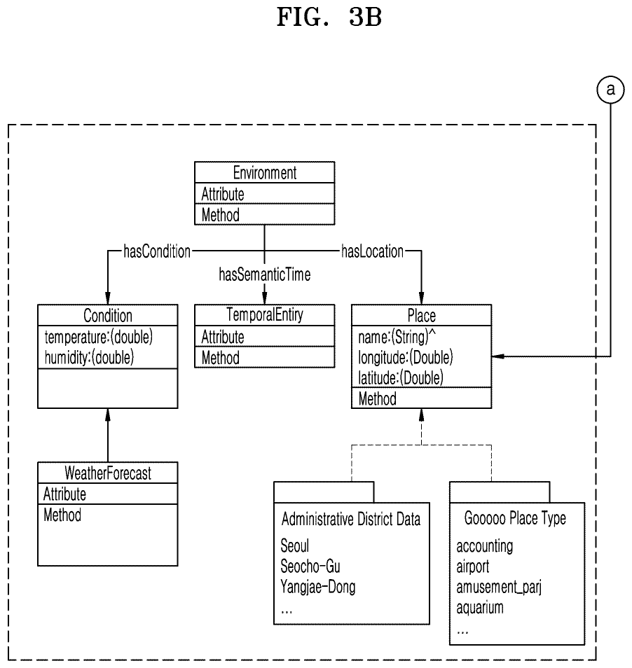

FIGS. 3A and 3B are diagrams illustrating a portion of a content ontology as an example of ontology used by the user device 100 to construct a personal knowledge graph, according to an embodiment of the disclosure.

Referring to FIGS. 3A and 3B, in the process of constructing the personal knowledge graph based on the user content, the user device 100 may generate data of a standardized form matching the ontology format by collecting metadata about content generated or provided by the user device 100, converting the collected metadata into a triple format, and then mapping the converted data to the content ontology stored in the semantic memory. At this time, the content ontology may be used in the process of constructing the personal knowledge graph based on the user content.

FIGS. 3A and 3B illustrate an example of the content ontology. The content ontology may be used to model content that a user consumes. The content ontology defines data items that may be collected for each type of content, and this is referred to as a “class.” The content ontology may include nodes corresponding to the respective classes and edges expressing a relationship between the respective classes, and sub-classes may inherit properties of super-classes. An instance is data items defined in a class through data collection and to which actual data values are applied, and each data item becomes knowledge property information of the instance. The instance may be generated to correspond to each class on the ontology. For example, in the case of the content ontology of FIGS. 3A and 3B, an instance corresponding to the highest level content may be generated, and a lower level instance, such as a person or an environment, may be generated. Actual data values may be recorded on the knowledge property information of the instance, or actual data values may be recorded on data items predefined with reference to classes of the same or different types of ontology. For example, in a media object illustrated in FIGS. 3A and 3B, actual data values matching data types may be recorded on data items, such as name, start time, end time, or creation date. In addition, in the media object, actual data values may be recorded according to data items defined in a “place” class of an environment ontology for a data item of a content location. In addition, in the media object, actual data values may be recorded according to data items defined in a “person” class of a content ontology for a data item of an author.

Collectable data items may be predefined in the class so that pieces of information remembered together when the user remembers content become knowledge property information of each instance in the personal knowledge graph based on the user content. When all data values for data items defined in the class are collected from various metadata related to the content without omission, the user device 100 may provide a user-friendly content search according to a method that the user remembers, by using a query including the knowledge property information and the personal knowledge graph based on the user content. When metadata about some objects constituting the content are missing or when some metadata about a certain object are missing, some values of knowledge property information of the instance of the corresponding content may be missing or empty, and thus, the user device 100 may not be able to search for the content.

The user device 100 may model user content through user modeling-based data collection using the content ontology. For example, the user device 100 may use the content ontology to obtain data of a standardized form matching an ontology format with respect to photos stored in the user device 100 and generate the personal knowledge graph based on the user content.

FIG. 4 is a diagram illustrating an operation performed by a user device to provide a personal knowledge graph-based service to a user, according to an embodiment of the disclosure.

Referring to FIG. 4, the user device 100 may provide a personalized service to a user through a personal knowledge graph-based service application. The user device 100 may construct a knowledge graph-based personalized database.

FIGS. 2, 3A, and 3B are knowledge graph-based personalized databases, and the following description is given on the assumption that a personal knowledge graph is constructed based on user content. An embodiment of the disclosure in which the user device 100 provides a content search service by using a query including a search term input by a user and a personal knowledge graph based on user content is described below, but the disclosure is not limited to such a service.

According to an embodiment of the disclosure, a service logic module included in a content finder part of the user device 100 may execute a content search service to receive a user input regarding a search term. The service logic module may transmit the search term input by the user to a retrieval unit. A text search module may transmit a result of performing simple text matching on the search term to the service logic module. The service logic module may provide search results based on results of collating text matching results and query results for the personal knowledge graph based on the user content and may apply rankings to the search results.

In the memory core part of the user device 100, the retrieval unit may derive an internationalized resource identifier (IRI) of the search term transmitted from the service logic module through the entity encoder. An entity encoder may support multilingual processing or synonym processing with respect to the search term by using a knowledge graph vocabulary database and a synonym database to convert the search term into a standard language registered in the knowledge graph and derive an IRI corresponding to the search term. The retrieval unit may construct a query using the IRI corresponding to the search term and receive a query result for the personal knowledge graph based on the user content. The query result for the personal knowledge graph based on the user content may include a list of IRIs of content related to the IRIs included in the query, knowledge property information of each content, type information or score information of the knowledge property information, type information of the content, etc. The knowledge property information of each content may be preset up to knowledge property information of an n-hop relationship with the content. The type information of the knowledge property information may be data item information (field information) predefined in a class when configuring the content ontology or separate type information defined for each node of each content. The retrieval unit may output a related search term based on the knowledge property information and/or the type information of the knowledge property information together with the search result based on the query result.

When the user input regarding the search term is a multisearch term, the service logic module may transmit the multisearch term input by the user to the retrieval unit. The case of a search using a multisearch term may include a case where a first search term and a second search term are input at the same time and a case where a second search term is additionally input after a first search term is input.

When the first search term and the second search term are input at the same time, the retrieval unit may derive an IRI corresponding to the first search term and an IRI corresponding to the second search term through the entity encoder. The retrieval unit may construct a query using the IRI corresponding to the first search term and a query using the IRI corresponding to the second search term, receive results of the respective queries, and obtain a final result corresponding to the intersection (or union) of the results of the respective queries.

In an embodiment of the disclosure, when the second search term is additionally input after the first search term is input, the retrieval unit may store, in a cache, a query result of the query using the IRI corresponding to the first search term. When the second search term is additionally input, the retrieval unit may obtain a final result of the multisearch term by deriving the IRI corresponding to the second search term and filtering the query result stored in the cache by using the IRI corresponding to the second search term. When the cache is used for the search using the multisearch term, a method of filtering the query result stored in the cache may be expected to obtain a fast response, compared to a method of performing the intersection of two query results.

When the user input regarding the search term is a multisearch term using operation symbols, the service logic module may transmit, to the retrieval unit, the multisearch term using operation symbols input by the user. The retrieval unit may parse the multisearch term using operation symbols and separately process the first search term, the operation symbols, and the second search term. The retrieval unit may perform a predefined operation on a first query result of the query using the IRI corresponding to the first search term and a second query result of the query using the IRI corresponding to the second search term according to the type of the operation symbol. For example, when the operation symbol is “+,” a result of integrating the first query result and the second query result may be output. When the operation symbol is “−,” a result of removing the second query result from the first query result may be output. When inputting the multisearch term, at least one operation symbol may be used, parentheses may be input, and operation symbols corresponding to operations defined by the user may be used.

On the other hand, when the instance corresponding to the search term input by the user is not present in the personal knowledge graph, it is possible to preset whether to output a query result for an instance corresponding to a higher class than a class of the instance corresponding to the search term. Furthermore, node information may be collected from a knowledge graph of an external server by using class information of the instance corresponding to the search term, a related search term in which the instance is present may be extracted in conjunction with a personal knowledge graph, and then, a search result may be provided. Furthermore, ontology including the class information of the instance corresponding to the search term may be downloaded from the external server, a related search term in which the instance is present may be extracted in conjunction with a personal knowledge graph, and then, a search result may be provided.

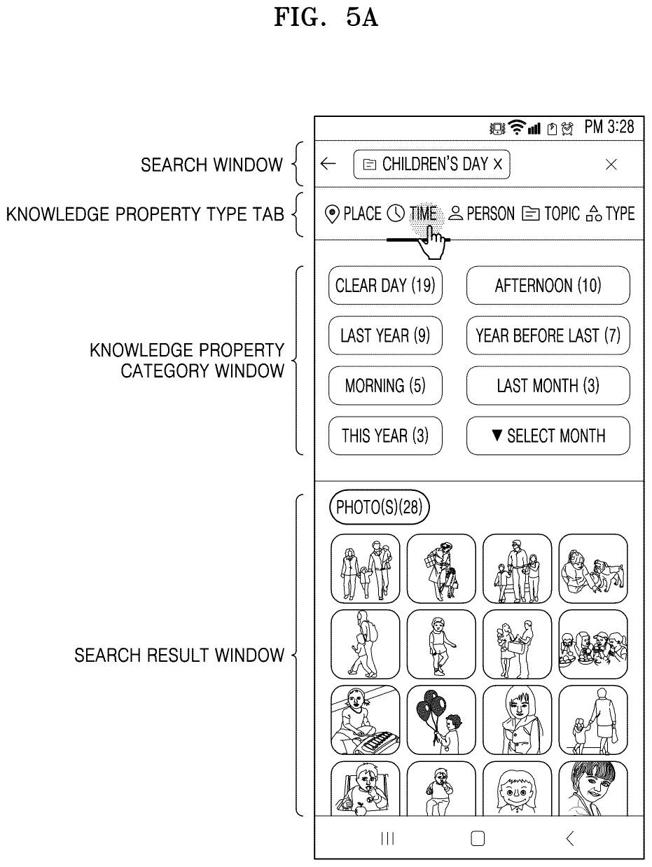

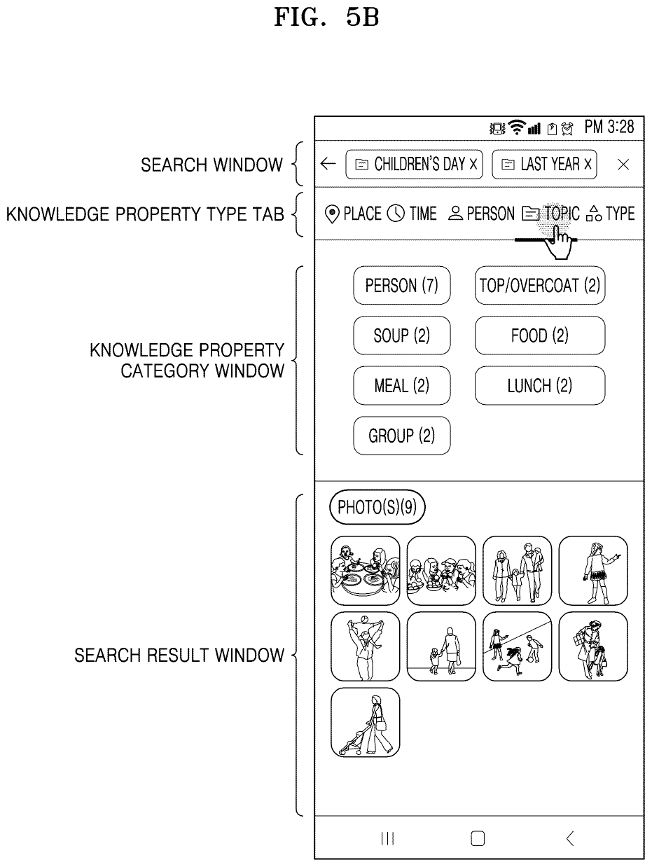

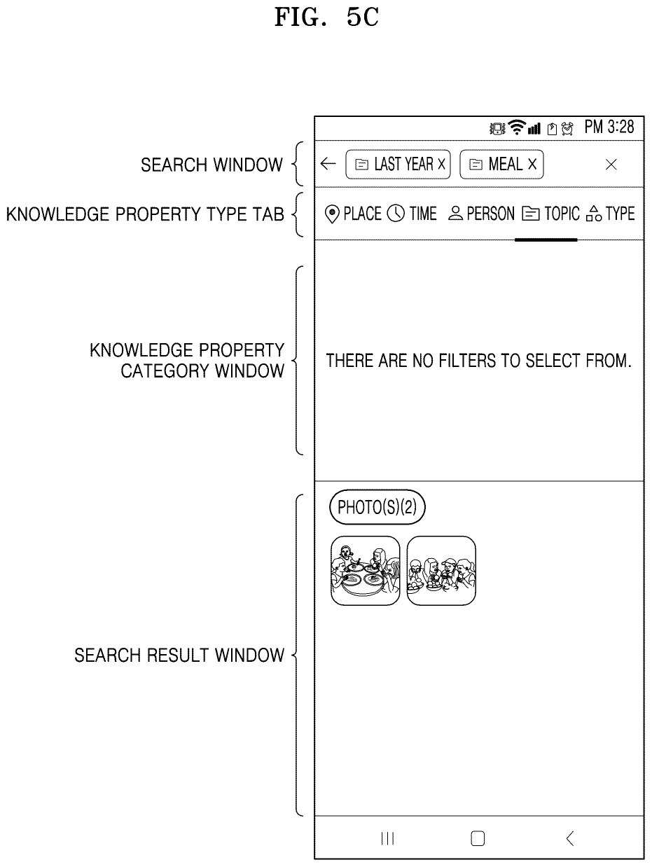

FIGS. 5A, 5B, and 5C are diagrams illustrating a process performed by the user device 100 to search for a photo by using a search term based on knowledge property information through a personal knowledge graph-based search application, according to an embodiment of the disclosure.

FIG. 5A illustrates a user interface screen (hereinafter, a “navigator”) of a personal knowledge graph-based search application. The navigator may include a search window, a knowledge property type tab, a knowledge property category window, and a search result window, and the positions, sizes, shapes, etc. thereof may be changed.

The search window may receive a user input regarding the search term. The user may directly input the search term by using a virtual keyboard overlapping a lower end of a screen, or may input the search term to the search window by selecting a related search term based on knowledge property information by using the knowledge property type tab and the knowledge property category window.

The knowledge property type tab may include a plurality of tabs separated by type of knowledge property information of each instance of the personal knowledge graph. As illustrated in FIG. 5A, the knowledge property type tab may include tabs corresponding to place, time, person, topic, and type for each type of the knowledge property information, but the disclosure is not limited thereto. For example, when the knowledge property information relates to the time when the content was captured, the corresponding instance may be classified as a time tab. The knowledge property type tab may be always displayed or may be displayed upon user interaction, depending on a user's settings, and may be provided in various ways, including drop-down, pop-up, new window, etc. A tab selected by the user among the plurality of tabs constituting the knowledge property type tab may be displayed so as to be distinct from other tabs.

The knowledge property category window may categorize knowledge property information of instances classified as each tab for each knowledge property type tab and provide information about the category names and the number of instances belonging to the corresponding category. The knowledge property information of the instance may be actual data values or information inferred from the actual data values. For example, when the knowledge property information of the instance is “wife,” the knowledge property information of the instance may be inferred and classified as “family.” When knowledge property information of a photo classified as each tab for each knowledge property type tab is not known, the user device 100 may infer candidate knowledge property information and use the inferred candidate knowledge property information, provide a thumbnail of the photo, or use the knowledge property type information as the knowledge property information.

A category name may be used as a search term. When the category name provided in the knowledge property category window is selected, the category name may be automatically input to the search window as a search term, and instances belonging to the corresponding category may be provided in the search result window. As illustrated in FIG. 5A, information about the category name and the number of instances belonging to the corresponding category may be expressed in the form of a term box, but the disclosure is not limited thereto, and the information may be provided in the form of a term cloud or a three-dimensional solid.

The knowledge property type tab and the knowledge property category window may be activated when the user inputs a search term, or may be activated without inputting a search term, based on a user's current specific action or predicted future action or certain context information.

The search result window may provide a search result corresponding to the search term input in the search window. According to an embodiment of the disclosure illustrated in FIG. 5A, where photos are searched for through the personal knowledge graph-based search application, the search result window may provide thumbnails of photos corresponding to the search term and information about the total number of photos corresponding to the search term.

FIGS. 5A, 5B, and 5C are diagrams illustrating navigators in a process performed by the user device 100 to search for photos by using the search term based on the knowledge property information through the personal knowledge graph-based search application, according to an embodiment of the disclosure.

Referring to FIG. 5A, the user device 100 may receive a search term “Children's Day” from the user in the search window. The user device 100 may derive an IRI of the search term “Children's Day,” construct a query using the IRI of the search term “Children's Day,” and receive a query result for the personal knowledge graph based on the user content. The query result for the personal knowledge graph based on the user content may include a list of IRIs of 28 photos related to the IRI of “Children's Day,” type information of knowledge property information of the photos, knowledge property information of the photos classified as each tab for each knowledge property type tab, score information of each knowledge property information, information indicating that the type information of the content is a photo, etc.

Referring to FIG. 5A, the user device 100 may display 28 photos in the search result window as the search result for “Children's Day,” categorize the knowledge property information of the photos classified as each tab for each knowledge property type tab in the knowledge property category window, and provide information about the category name and the number of photos belonging to the corresponding category. As illustrated in FIG. 5A, the knowledge property information of the photos classified as the time tab of the knowledge property type tab is categorized into “clear day,” “afternoon,” “last year,” “the year before last,” “morning,” “last month,” “this year,” and “OO month,” and information about the number of photos belonging to each category may be displayed in the knowledge property category window together with the category name. The category names, such as “clear day,” “afternoon,” “last year,” “the year before last,” “morning,” “last month,” “this year,” and “OO month” may be used as search terms that the user may associate with. When “last year” is selected from the category names provided in the knowledge property category window of FIG. 5A, “last year” may be additionally input as the search term in the search window and nine photos belonging to the “last year” category may be provided in the search result window, as illustrated in FIG. 5B. When the user selects the topic tab in the knowledge property type tab, knowledge property information of photos classified as the topic tab of the knowledge property type tab is categorized into “person,” “top/overcoat,” “soup,” “food,” “meal,” “lunch,” and “group” and information about the number of photos belonging to each category may be displayed in the knowledge property category window together with the category name, as illustrated in FIG. 5B. The category names, such as “person,” “top/overcoat,” “soup,” “food,” “meal,” “lunch,” and “group” may be used as search terms that the user may associate with. When “meal” is selected from the category names provided in the knowledge property category window of FIG. 5B, “meal” may be additionally input as the search term in the search window and two photos belonging to the “meal” category may be provided in the search result window, as illustrated in FIG. 5C.

On the other hand, when the user input for the search term is a multisearch term, for example, when “Children's Day” is received as the first search term and “last year” is received as the second search term, the user device 100 may obtain a query result of a query using an IRI corresponding to “Children's Day” and a query result of a query using an IRI corresponding to “last year” and then provide a result shown in FIG. 5B as a final result corresponding to the intersection of the respective query results.

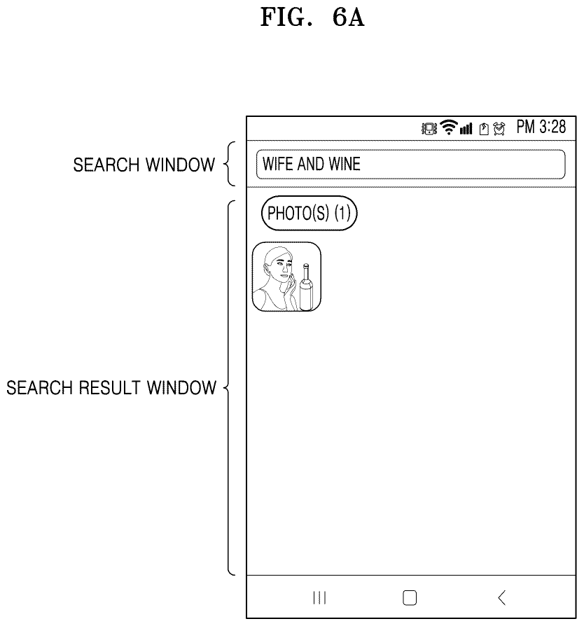

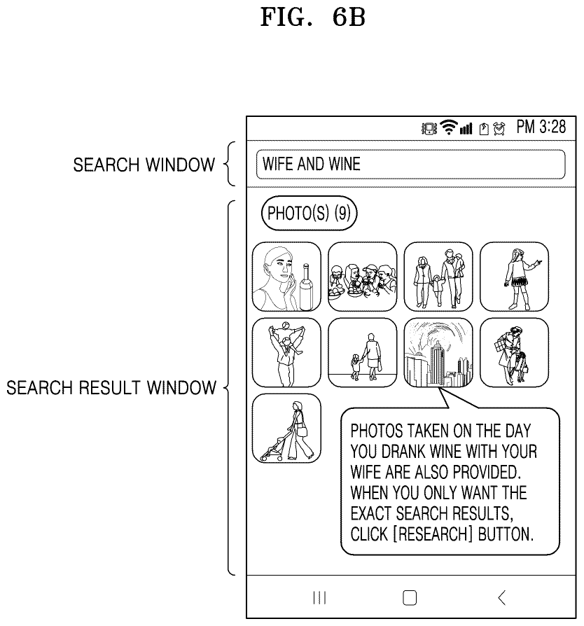

FIGS. 6A and 6B are diagrams illustrating a comparison of states in which the user device 100 provides different search results for the same search term according to an embodiment of the disclosure.

Referring to FIGS. 6A and 6B, a search result window includes a photo searched for by using a search term “wife and wine” input to a search window by the user device 100.

Referring to FIG. 6A, the user device 100 may display one photo as the search result for “wife and wine” in the search result window in response to receiving the search term “wife and wine” input to the search window. In FIG. 6A, the user device 100 may obtain one photo in which both the wife and the wine appear as a query result for a personal knowledge graph based on user content and provide the obtained photo to the user within a short period of time. The personal knowledge graph based on the user content may use nodes and edges to represent instances of content collected by using photos or videos owned by the user, message information transmitted and received by the user, etc.

Referring to FIG. 6B, the user device 100 displays nine photos as the search result for “wife and wine” in the search result window in response to receiving the search term “wife and wine” input to the search window. In FIG. 6B, the user device 100 obtains not only one photo in which both the wife and the wine appear, but also the photos taken on the day the photo was taken, as a query result for a personal knowledge graph based on user content, and provides various photos to the user.

When the user's intention in inputting the search term is to view only photos closely related to the search term in a short period of time, the search result window of FIG. 6A may be a result that matches the user's intention, but when the user's intention in inputting the search term is to obtain various information related to the search term, the search result window of FIG. 6B may be a result that matches the user's intention. For example, when the user inputs the search term because the user could not remember what other events the user had on the day the user drank wine with his wife, or because the user is curious about where the restaurant was that day, the search result window of FIG. 6B may provide search results that better match the user's intention.

In FIGS. 6A and 6B, an example in which the user searches for photos stored in the user device 100 by using the search term has been described, but the disclosure is not limited thereto. According to an embodiment of the disclosure, the search may be for various content, such as videos, messages, articles, social network service (SNS) posts, etc., as well as photos.

Hereinafter, a method of providing search results that better match a user's search context, including the user's intention, is described.

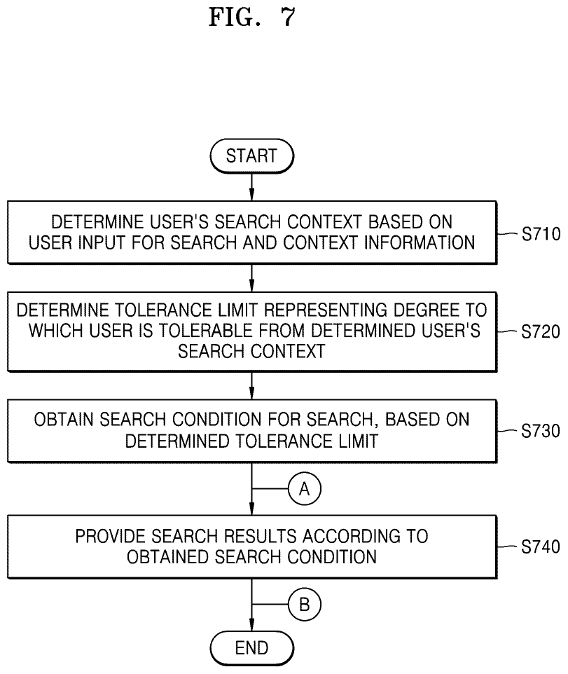

FIG. 7 is a flowchart illustrating a method of providing search results based on a user's search context, according to an embodiment of the disclosure.

Referring to FIG. 7, in operation S710, the user device 100 may determine a user's search context based on a user input for a search and context information. The user device 100 may further use commonsense or fact knowledge as well as the user input and the context information, to determine the user's search context.

The search may be a search utilized in a personalized AI service using a personal knowledge graph. The personal knowledge graph may be generated by using information obtained by the user device 100, and various types of personal knowledge graphs may be generated. The search in the disclosure may be a search performed to provide information in a search service, a recommendation service, an assistant service, or a QA service.

The user input may be in the form of text, voice, or gestures, but the disclosure is not limited thereto. The user may input a search command in the form of a search term or sentence for a search through a user interface or a microphone of the user device 100. The user may provide the user input for a search to the user device 100 by using a predefined gesture or action (e.g., an action of shaking the user device 100).

The user device 100 may determine keywords, meanings, temporal constraints, spatial constraints, etc. from the user input through at least one analysis model, such as a natural language processing model, a voice analysis model, or a gesture analysis model. For example, when there is a user input, such as “Where is a good restaurant for lunch near Seoul Station?,” the user device 100 may extract keywords, such as “Seoul Station,” “lunch,” “restaurant,” “where,” etc., from the entire sentence and infer that the user is requesting a food or restaurant recommendation. In addition, the user device 100 may determine that there is a temporal constraint of “lunchtime” and a spatial constraint of “near Seoul Station.”

The context information is information about the status, condition, environment, etc. when the user device 100 provides a service. For example, when the user device 100 performs a search and provides a certain service, the context information may be user information, time information, location information, other sensing information, information about available hardware resources of the user device 100, etc. The user information may include a user's personality, a user's behavioral patterns, a user's past input, a user's feedback on the provided service, etc., and may be obtained from information directly input by the user or information accumulated in the user database. The time information and the location information are information about the time and location when the user device 100 provides a certain service through a search, and may be respectively obtained through a timer and a global positioning system (GPS) of the user device 100. The other sensing information may be information that may be obtained by tracking and observing various sensors mounted on the user device 100, such as information about a user's movement speed or information about a user's health condition. The information about available hardware resources of the user device 100 may be information about a processing operation module or memory used for a search task.

The user device 100 may obtain context information through various types of sensors or various databases, such as personal knowledge graphs or knowledge graphs storing commonsense.

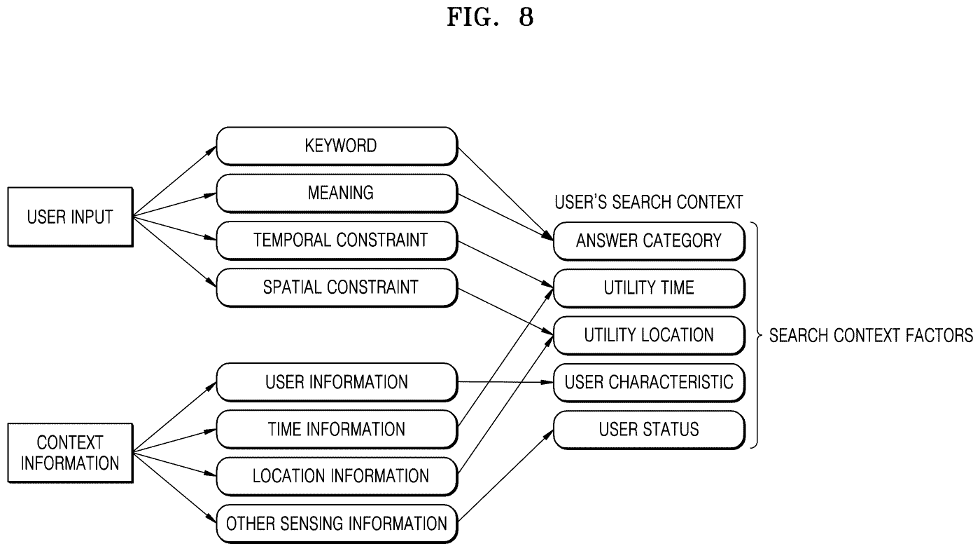

FIG. 8 is a diagram illustrating a process of determining a user's search context based on a user input and context information, according to an embodiment of the disclosure.

The user device 100 may determine a plurality of search context factors, which form a user's search context, from a user input and context information. The user's search context may include a user's intention regarding the search. The user's search context may further include information about a user's intension input by the user, a user's intension that is inferred or estimated, a time the user may wait, which is input by the user, an inferred or estimated time the user may wait, an available device space, and available memory. The user's search context may be formed through a plurality of search context factors. Each of the search context factors may be inferred or determined from at least one of the user input or the context information. The user device 100 may determine a plurality of search context factors that form the user's search context, based on at least one of a keyword extracted from the user input, a meaning inferred from the user input, or a constraint related to the search and at least one of information about the user, time information, location information, or sensing information obtained by the user device, which is obtained as context information.

Referring to FIG. 8, the search context factors that form the user's search context are listed as an answer category, a utility time, a utility location, a user characteristic, and a user status, but the disclosure is not limited thereto. Different types of search context factors that are different from those illustrated in FIG. 8 may exist, or some search context factors may not be inferred, depending on the user input or the context information.

The answer category may be determined by inferring how the answer to the user input should be achieved. The user device 100 may infer what requirements the user input includes and may classify to which answer category the user input corresponds. The user device 100 may determine the answer category based on the keyword extracted from the user input and the meaning inferred from the user input. The user device 100 may previously determine a plurality of answer categories and may determine which answer category the user input is related to. For example, the user device 100 may distinguish whether the user input requests a short answer, whether the user input requests a location recommendation, whether the user input requests a search result for content within a certain range, or whether the user input requests an answer to a general commonsense.

The utility time may be determined by determining whether the user input includes temporal constraints. The user device 100 may determine whether the user input includes a time-related expression. The user device 100 may determine the utility time based on current time information and the temporal constraints determined from the user input. For example, the user device 100 may determine, as the utility time, the remaining time for which the answer is expected to be valid, based on the current time information and the temporal constraints extracted from the user input.

The utility location may be determined by determining whether the user input includes spatial constraints. The user device 100 may determine whether the user input includes a location-related expression. The user device 100 may determine the utility location based on current location information and the spatial constraints determined from the user input. For example, the user device 100 may determine, as the utility location, the location or region in which the answer is expected to be valid, based on the current location information and the spatial constraints extracted from the user input.

The user characteristic may be determined from the user information received as the context information. The user device 100 may determine a user's behavioral pattern from a user's personality or repeated actions directly input by the user. The user device 100 may identify a user characteristic from accumulated information, such as a user input that was input in the past or a user feedback on services provided in the past. For example, the user device 100 may determine, as the user information, whether the user is impatient or what type of answer he or she prefers.

The user status may be determined from other sensing information received as the context information. The user device 100 may determine the user status by tracking data regarding the user from sensors mounted on the user device 100. The user device 100 may identify the user status from a user's location movement, a user's motion, and a user's bio-signals. For example, the user device 100 may determine whether the user is moving quickly, whether the user is in an emergency situation, etc. as the user status.

Referring again to FIG. 7, in operation S720, the user device 100 may determine a tolerance limit representing a degree to which the user is tolerable from the determined user's search context. The tolerance limit is a certain indicator for a search. As the value of the tolerance limit is lower, faster and more immediate search results are provided. As the value of the tolerance limit is higher, more search results are provided although it takes time. The tolerance limit may vary depending on the user's search context. The tolerance limit may vary from user to user, and even for the same user, the tolerance limit may vary depending on the user's context or the user input. The tolerance limit may be determined based on a plurality of tolerance limit elements.

The user device 100 may obtain a tolerance limit based on a plurality of tolerance limit elements corresponding to a plurality of search context factors. The user device 100 may determine a tolerance limit element corresponding to each search context factor with respect to each search context factor, and may determine a tolerance limit based on all determined tolerance limit elements.

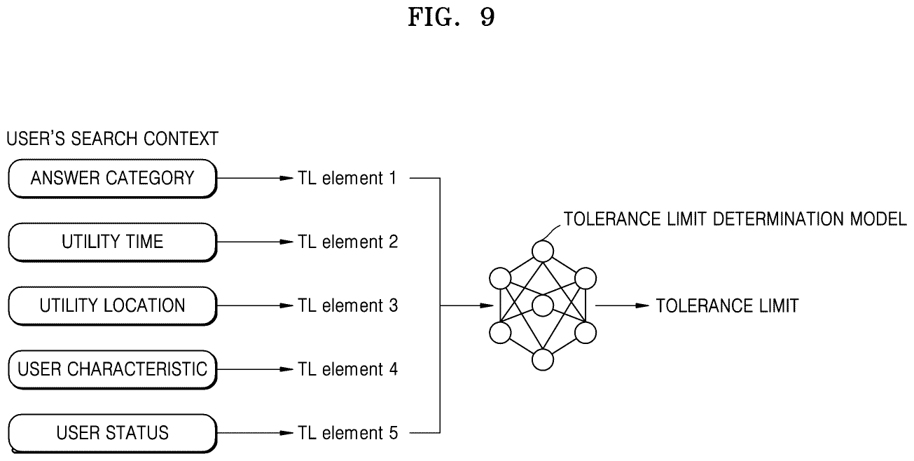

FIG. 9 is a diagram illustrating a process of determining a tolerance limit from a user's search context, according to an embodiment of the disclosure.

Referring to FIG. 9, an example in which a user's search context is formed by a plurality of search context factors is illustrated, but this is for illustrative purposes only, and the disclosure is not limited to this example. The example of FIG. 9 shows five search context factors: answer category, utility time, utility location, user characteristic, and user status, and shows five tolerance limit elements corresponding to the five search context factors.

When there is a search context factor “answer category” (hereinafter, a first search context factor), a tolerance limit element corresponding to the answer category (hereinafter, a first tolerance limit element) may be determined. The user device 100 may determine a value of the first tolerance limit element according to a value of the first search context factor. The user device 100 may determine a low value for the first tolerance limit element when the first search context factor corresponds to an answer category requiring a short answer. The user device 100 may determine a high value for the first tolerance limit element when the first search context factor corresponds to an answer category requiring a commonsense knowledge.

For example, when there is a user input of “Tell me about a nearby restaurant,” the user device 100 may determine that the user input is an answer category requiring a short answer, and may set the first tolerance limit element to a low value. On the other hand, when there is a user input of “Why is the sky blue?,” the user device 100 may determine that the user input is an answer category requiring a commonsense knowledge, and may set the first tolerance limit element to a high value.

When there is a search context factor “utility time” (hereinafter, a second search context factor), a tolerance limit element corresponding to the utility time (hereinafter, a second tolerance limit element) may be determined. The user device 100 may determine a value of the second tolerance limit element according to a value of the second search context factor. When the user device 100 determines that the utility time, which is the second search context factor, is short, the remaining time expected for the answer to be valid is short. Accordingly, a low value may be determined for the value of the second tolerance limit element. When the user device 100 determines that the utility time, which is the second search context factor, is long, the remaining time expected for the answer to be valid is long. Accordingly, a high value may be determined for the value of the second tolerance limit element.

For example, in a case where the user's input is a request for “recommendation of a lunch place,” when the current time information is “12:00 PM” and when the current time information is “10:00 AM,” the user device 100 may determine that the utility time is short for the former and may set the second tolerance limit element to a low value. On the other hand, the user device 100 may determine that the utility time is long for the latter and may set the second tolerance limit element to a high value.

When there is a search context factor “utility location” (hereinafter, a third search context factor), a tolerance limit element corresponding to the utility location (hereinafter, a third tolerance limit element) may be determined. The user device 100 may determine a value of the third tolerance limit element according to a value of the third search context factor. When the user device 100 determines that the utility location, which is the third search context factor, is narrow, the range of the location expected for the answer to be valid is narrow. Accordingly, a low value may be determined for the value of the third tolerance limit element. When the user device 100 determines that the utility location, which is the third search context factor, is wide, the range of the location expected for the answer to be valid is wide. Accordingly, a high value may be determined for the value of the third tolerance limit element.

For example, in a case where the current location information is ‘Seoul Station’, when the user input is a request for “recommendation of a good restaurant near Seoul Station” and when the user input is “recommendation of a good restaurant in Seoul,” the user device 100 may determine that the utility location is narrow for the former due to the spatial constraint of “near Seoul Station” and may set the third tolerance limit element to a low value. On the other hand, the user device 100 may determine that the utility location is wide for the latter and may set the third tolerance limit element to a high value.

When there is a search context factor “user characteristic” (hereinafter, a fourth search context factor), a tolerance limit element corresponding to the user characteristic (hereinafter, a fourth tolerance limit element) may be determined. The user device 100 may determine a value of the fourth tolerance limit element according to a value of the fourth search context factor. The user device 100 may determine the value of the fourth tolerance limit element according to an output value of a user characteristic estimation model that receives user information or information about a user characteristic, or a value about a user characteristic preset by the user.

For example, when the user sets his or her personality as “urgent” on the user device 100, the user device 100 may determine that the value of the search context factor “user characteristic” is low and may set the fourth tolerance limit element to a low value. When the user device 100 determines that the output value of the user characteristic estimation model based on a user's age, speaking speed, a user's past feedback, etc. is high, the user device 100 may set the fourth tolerance limit element to a high value.

When there is a search context factor “user status” (hereinafter, a fifth search context factor), a tolerance limit element corresponding to the user status (hereinafter, a fifth tolerance limit element) may be determined. The user device 100 may determine a value of the fifth tolerance limit element according to a value of the fifth search context factor. The user device 100 may determine a low value for the fifth tolerance limit element when the user status based on other sensing information requires urgent search results. The user device 100 may determine a high value for the fifth tolerance limit element when the user status based on other sensing information is relaxed and not urgent.

For example, when the user is driving and moving quickly or when the user is in an emergency situation, the user device 100 may determine that the value of the search context factor “user status” is low and may set the fifth tolerance limit element to a low value. On the other hand, when the user is resting or is not busy because there is no schedule registered on a user's calendar, the user device 100 may determine that the value of the search context factor “user status” is high and may set the fifth tolerance limit element to a high value.

According to an embodiment of the disclosure, the user device 100 may obtain a tolerance limit according to an output value of a certain function or a certain learning model, which receives at least one of a plurality of tolerance limit elements as input. The certain function may be a function that outputs a certain value through a certain operation among the values of the tolerance limit elements or selects a certain value in accordance with a certain rule among the values of the tolerance limit elements. Alternatively, the certain function may be a function that calculates a mean, such as an arithmetic mean, a harmonic mean, a geometric mean, or a weighted mean of the values of the tolerance limit elements, or outputs a minimum or maximum value among the values of the tolerance limit elements. Alternatively, the certain function may be a function that receives at least one of the values of the tolerance limit elements as input and outputs a certain operation result. The certain learning model may be a tolerance limit determination model in the form of a deep learning model or a machine learning model, which receives at least one of the values of the tolerance limit elements as input.

For example, the user device 100 may determine, as the tolerance limit, the tolerance limit element having the lowest value among the plurality of tolerance limit elements. Alternatively, the user device 100 may determine the tolerance limit by using the certain function or the certain learning model, based on a certain number of tolerance limit elements that are previously obtained.

When the user device 100 is unable to determine a tolerance limit element corresponding to some search context factors, the user device 100 may obtain a tolerance limit based on the determined tolerance limit elements, or obtain a tolerance limit by applying a default value to the tolerance limit elements that are not determined. When the values of all tolerance limit elements are not determined, the user device 100 may determine a certain predefined value as the tolerance limit.

Referring again to FIG. 7, in operation S730, the user device 100 may obtain a search condition for a search, based on the determined tolerance limit. The search condition refers to a condition that may qualitatively or quantitatively affect search results when the user device 100 performs a search.

The search condition may be a query condition used in a query generated by the user device 100 to correspond to the user input for the search. The user device 100 may obtain a query condition that affects a search time, based on the determined tolerance limit. The user device 100 may adaptively change the query condition based on the determined tolerance limit.

The query condition that affects the search time may be based on at least one of a search scope in a user's personal knowledge graph or a limitation on knowledge property information of each node in a personal knowledge graph. The search scope in the personal knowledge graph may include at least one of the number of nodes to be searched for among nodes constituting the personal knowledge graph or the level of the node in the personal knowledge graph. For example, the user device 100 may adjust the number of nodes to be searched for or limit a search target to a node of a specific level, according to the tolerance limit. The limitation on the knowledge property information of each node of the personal knowledge graph may include the specification of at least one knowledge property information in a list of knowledge property information defined for the class of each node. For example, the user device 100 may limit the search target to nodes where the value of the certain knowledge property information is a specific value (e.g., in the case of a photo, a photo taken during a specific period or at a specific location, or a photo including a specific object) according to the tolerance limit.

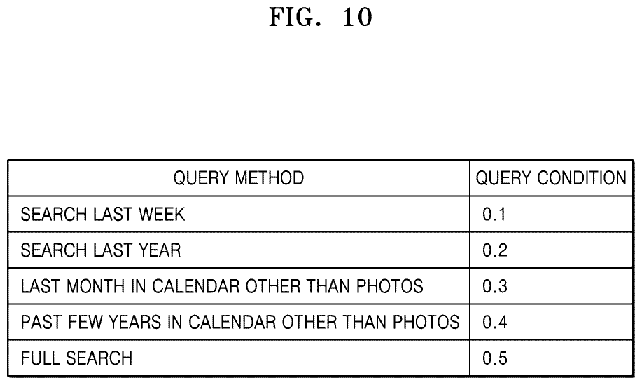

FIG. 10 is a diagram illustrating an example of a query condition affecting a search time, according to an embodiment of the disclosure.

Referring to FIG. 10, an example of a query condition used for a search when the user device 100 searches for content stored in the user device 100 according to a user input is illustrated. As illustrated in FIG. 10, the query condition may be a preset certain value corresponding to a query method, but the disclosure is not limited thereto.

In FIG. 10, a query condition of “0.1,” means searching for photos taken within the last week. A query condition of “0.2,” means searching for photos taken within the last year. When the query condition is “0.2,” more photos are searched for, compared to when the query condition is “0.1.” Accordingly, a search may take more time.

In FIG. 10, a query condition of “0.3,” means searching for content stored in the calendar as well as photos taken within the last month. Because a search when the query condition is “0.3” is a complex search that searches for a plurality of types of content, it may take more time to search, compared to a simple search when the query condition is “0.1” and “0.2.” A query condition of “0.4,” means searching for content stored in the calendar as well as photos taken within the past few years. When the query condition is “0.4,” content generated over a longer period of time is searched for, compared to when the query condition is “0.3.” Accordingly, a search may take more time. Because a search when the query condition is “0.5” is a full search with no limitation on the search target and period, a search may take the most time.

Accordingly, the user device 100 may obtain a query condition that is closer to the query condition of “0.1” as the tolerance limit is lower, and may obtain a query condition that is closer to the query condition of “0.5” as the tolerance limit is higher. The user device 100 may apply, to a query, a query condition closest to the value of the determined tolerance limit value.

The search condition may be a search environment condition including allocation of hardware resources of the user device 100 which are used for the search. Limited hardware resources, such as a processing operation module or memory, which are used to perform a search, may be mounted on the user device 100. Therefore, for efficient use of the hardware resources, the user device 100 may obtain a search environment condition including allocation of the hardware resources of the user device 100 used for the search, based on the determined tolerance limit. The user device 100 may flexibly and dynamically change the search environment condition based on the determined tolerance limit. The user device 100 may allocate more processing operation modules and/or memories as the value of the tolerance limit decreases, and the user device 100 may allocate fewer processing operation modules and/or memories as the value of the tolerance limit increases.

Referring again to FIG. 7, in operation S740, the user device 100 may provide search results according to the obtained search condition. The user device 100 may perform a search according to the obtained search condition. For example, the user device 100 may perform a search according to the obtained query condition. The user device 100 may perform a search in the obtained search environment condition. The user device 100 may perform a search according to the obtained query condition and the obtained search environment condition. After the user device 100 performs a search, the user device 100 may provide search results to the user.

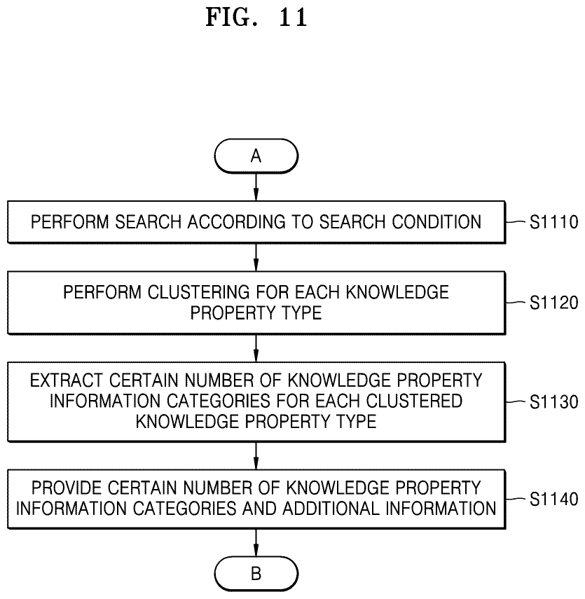

FIG. 11 is a detailed flowchart illustrating a process of providing search results, according to an embodiment of the disclosure.

Referring to FIG. 11, in operation S1110, the user device 100 may perform a search according to a search condition. The user device 100 may perform filtering from a node searched in a personal knowledge graph to a hop node at a certain distance, or extract search results according to a user's usage pattern or preference.

In operation S1120, the user device 100 may perform clustering on the search results with respect to each knowledge property type. For example, when the types of knowledge property information are place, time, person, and topic, the knowledge property information of all nodes included in the search results may be identified and the search results may be clustered for each type.

In operation S1130, the user device 100 may extract a certain number of top knowledge property information categories for each clustered knowledge property type. The user device 100 may perform N categorizations based on the knowledge property information of instances for each clustered knowledge property type, and then extract the top K knowledge property information categories so as to obtain the highest information gain (wherein N is greater than or equal to K). The user device 100 may categorize the knowledge property information of each instance into N pieces of representative knowledge property information. For example, the user device 100 may categorize instances of each clustered knowledge property type into N pieces of representative knowledge property information in a bottom-up method of performing merging upward from knowledge property distinguished at the lowest level or in a top-down method of performing distinction by performing operations on each representative knowledge property defined in advance. Thereafter, the user device 100 may extract the top K knowledge property information categories based on the relevance to the search term, knowledge property ranking, etc. Accordingly, nodes at unnecessary specific levels may be pruned, only nodes at a desired level may be provided as search results, and only the top K knowledge property information categories may be selected. Accordingly, the problem of limited display space of the user device 100 may be solved, and search results with the highest information gain may be provided to the user.

In operation S1140, the user device 100 may provide a certain number of top knowledge property information categories for each knowledge property type and additional information for each knowledge property information category. The additional information for each knowledge property information category may be the number of instances belonging to the corresponding category.

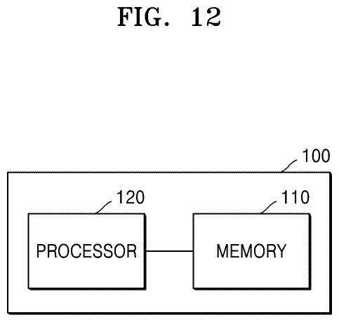

FIG. 12 is a block diagram illustrating a user device according to an embodiment of the disclosure.

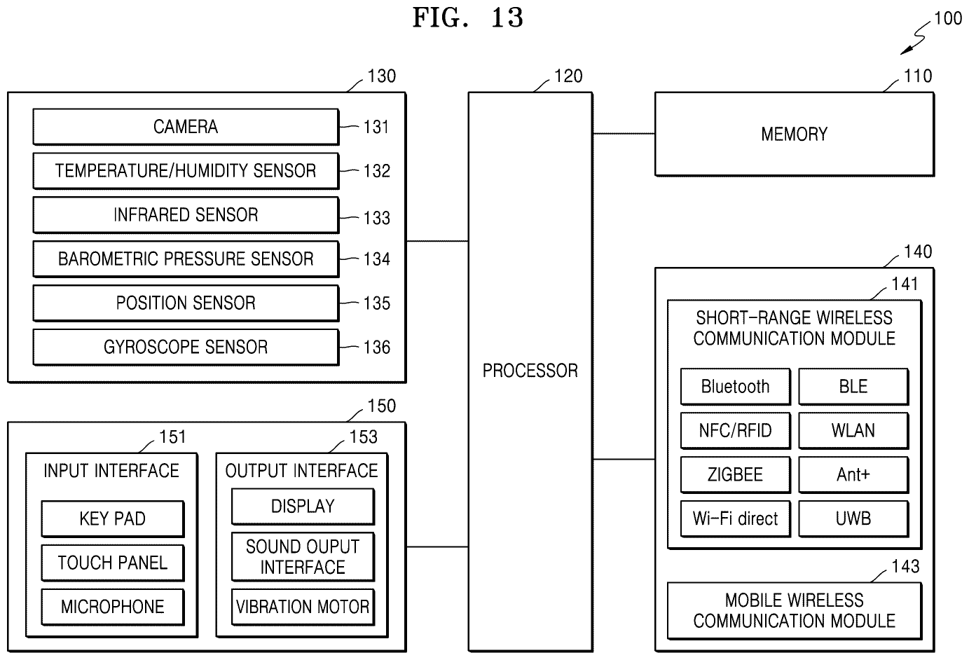

FIG. 13 is a block diagram illustrating a configuration and an operation of a user device according to an embodiment of the disclosure.

Referring to FIGS. 12 and 13, the user device 100 may include memory 110 and a processor 120, but the disclosure is not limited thereto, and a general-purpose configuration may be further added. For example, as illustrated in FIG. 13, the user device 100 may further include, in addition to the memory 110 and the processor 120, a sensing module 130, a communication module 140, and an input/output interface 150. Hereinafter, the respective elements are described in detail with reference to FIGS. 12 and 13.

The memory 110 may store a program for processing and control by the processor 120 and may store data and information input to or generated from the user device 100. The memory 110 may store instructions, a data structure, and program code, which are readable by the processor 120. Operations performed by the processor 120 may be implemented by executing instructions or program codes stored in the memory 110.

The memory 110 may include flash memory-type memory, hard disk-type memory, multimedia card micro-type memory, or card-type memory (e.g., secure digital (SD) or extreme digital (XD) memory), may include a non-volatile memory including at least one of read-only memory (ROM), electrically erasable programmable read-only memory (EEPROM), programmable read-only memory (PROM), magnetic memory, magnetic disc, or optical disc, and may include a volatile memory, such as random access memory (RAM) or static random access memory (SRAM).

The memory 110 may store one or more instructions and/or programs that control the user device 100 to train a neural network model or utilize a neural network model.

The processor 120 may execute instructions or programmed software modules stored in the memory 110 to control operations or functions so that the user device 100 may perform tasks. The processor 120 may include hardware components that perform arithmetic, logic, and input/output operations and signal processing. The processor 120 may execute one or more instructions stored in the memory 110 to control the overall operation of the user device 100. The processor 120 may execute programs stored in the memory 110 to control the sensing module 130 including at least one sensor, the communication module 140, and the input/output interface 150.

The processor 120 may include various processing circuitries and/or a plurality of processors. For example, the term “processor” as used herein, including the claims, may include various processing circuitries including at least one processor. “At least one processor” may be individually and/or collectively configured to perform various functions described herein. As used herein, the “processor,” “at least one processor,” and “one or more processors” may be configured to perform various functions. However, these terms may cover, without limitation, a situation where one processor performs some functions and other processor(s) perform other functions, and a situation where a single processor may perform all the functions. In addition, the “at least one processor” may include a combination of processors that perform the disclosed various functions in a distributed manner. The “at least one processor” may execute program instructions to accomplish or perform various functions.

The processor 120 may include, for example, at least one of a CPU, a microprocessor, a GPU, an application specific integrated circuit (ASIC), a DSP, a digital signal processing device (DSPD), a programmable logic device (PLD), a field programmable gate array (FPGA), an AP, an NPU, or a dedicated AI processor designed with a hardware structure specialized for processing an AI model, but the disclosure is not limited thereto. Each processor constituting the processor 120 may be a dedicated processor that performs a certain function.

The AI processor may use an AI model to perform calculation and control to process a task set to be performed by the user device 100. The AI processor may be manufactured in the form of a dedicated hardware chip for AI, or may be manufactured as part of a general-purpose processor (e.g., a CPU or an AP) or a GPU and mounted on the user device 1.

The sensing module 130 may include a plurality of sensors configured to sense information about the surrounding environment of the user device 100. For example, the sensing module 130 may include a camera 131, a temperature/humidity sensor 132, an infrared sensor 133, a barometric pressure sensor 134, a position sensor 135, a gyroscope sensor 136, or the like, but the disclosure is not limited thereto. Because the functions of the sensors may be intuitively inferred from the names of the sensors by those of ordinary skill in the art, the functions of the sensors are briefly described below.

The camera 131 may include a stereo camera, a mono camera, a wide-angle camera, an around-view camera, or a three-dimensional (3D) vision sensor. The temperature/humidity sensor 132 may measure a temperature or humidity of a position where the user device 100 is located. The infrared sensor 133 may be an active infrared sensor that senses a change by radiating infrared light and blocking the light, or a passive infrared sensor that does not have a light emitter and only senses a change in infrared light received from the outside. The barometric pressure sensor 134 may measure a barometric pressure at a position where the user device 100 is located. The position sensor 135 may detect the position of the user device 100. For example, the position sensor 135 may be a global positioning system (GPS). The gyroscope sensor 136 may detect angular velocity. The gyroscope sensor 136 may be used to measure the position of the user device 100 and set the moving direction of the user device 100.

The communication module 140 may include one or more components that enable the user device 100 to communicate with an external device, for example, a server or other electronic devices. For example, the communication module 140 may include a short-range wireless communication module 141, a mobile wireless communication module 143, or the like, but the disclosure is not limited thereto.

The short-range wireless communication module 141 may include a Bluetooth communication module, a Bluetooth Low Energy (BLE) communication module, a Near Field Communication (NFC) communication module, a wireless local area network (WLAN) (Wi-Fi™) communication module, a ZigBee communication module, an Ant+ communication module, a Wi-Fi Direction (WFD) communication module, an Ultra-Wideband (UWB) communication module, an Infrared Data Association (IrDA) communication module, a micro wave (uWave) communication module, or the like, but the disclosure is not limited thereto.

The mobile wireless communication module 143 may transmit and receive radio signals to and from at least one of a base station, an external terminal, or a server on a mobile communication network. The radio signals may include voice call signals, video call signals, or various types of data according to text/multimedia message transmission and reception.

The input/output interface 150 may include an input interface 151 and an output interface 153. In the input/output interface 150, the input interface 151 and the output interface 153 may be provided in a separated form or may be provided in an integrated form, such as a touch screen. The input/output interface 150 may receive input information from the user and provide output information to the user.

The input interface 151 may refer to a means for obtaining the user input for controlling the user device 100. For example, the input interface 151 may include a key pad, a touch panel (a contact capacitance type touch panel, a pressure resistance film type touch panel, an infrared detection type touch panel, a surface ultrasonic conduction type touch panel, an integral tension measurement type touch panel, a piezo effect type touch panel, etc.), or a microphone, but the disclosure is not limited thereto. In addition, the input interface 151 may include a gaze tracking sensor, a jog wheel, a jog switch, or the like, but the disclosure is not limited thereto.

The output interface 153 may output an audio signal, a video signal, or a vibration signal, and the output interface 153 may include a display, a sound output interface, and a vibration motor. The display may display information processed by the user device 100. For example, the display may display a user interface that receives a user's manipulation. When the display and a touch pad are configured as a touch screen having a layer structure, the display may be used as an input device as well as an output device. The display may include at least one of a liquid crystal display, a thin-film transistor-liquid crystal display, an organic light-emitting diode, a flexible display, or a 3D display. The user device 100 may include two or more display according to the implementation mode of the user device 100. The sound output interface may output audio data stored in the memory 110. The sound output interface may output sound signals related to the functions performed by the user device 100. The sound output interface may include a speaker, a buzzer, or the like.

The user device 100 according to an embodiment of the disclosure may include the memory 110 including one or more storage media storing at least one instruction and at least one processor 120 including a processing circuit. The at least one processor 120 may be configured to execute the at least one instruction to load and execute instructions or code for a certain module. According to an embodiment of the disclosure, the at least one processor 120 may be configured to execute the at least one instruction to load and execute instructions or code for a user intention analysis module, a tolerance limit determination module, a search condition determination module, and a search result provision module.

The at least one processor 120 of the user device 100 according to an embodiment of the disclosure may be configured to execute the at least one instruction to determine a user's search context based on a user input for a search and context information. According to an embodiment of the disclosure, the at least one processor 120 may further use commonsense or fact knowledge as well as the user input and the context information, to determine the user's search context.

The user input may be in the form of text, voice, or gestures, but the disclosure is not limited thereto. The user may input a search command in the form of a search term or sentence for a search through a user interface or a microphone provided in the input/output interface 150 of the user device 100. The user may provide the user input for a search to the user device 100 by using a predefined gesture or action. According to an embodiment of the disclosure, the at least one processor 120 may determine keywords, meanings, temporal constraints, spatial constraints, etc. from the user input through at least one analysis model, such as a natural language processing model, a voice analysis model, or a gesture analysis model.

The context information is information about the status, conditions, environment, etc. when the user device 100 provides a service. For example, when the user device 100 performs a search and provides a certain service, the context information may be user information, time information, location information, other sensing information, etc. According to an embodiment of the disclosure, the at least one processor 120 may obtain context information through various types of sensors or various databases, such as personal knowledge graphs or knowledge graphs storing commonsense.

According to an embodiment of the disclosure, the at least one processor 120 may determine a plurality of search context factors, which form the user's search context, from the user input and the context information. The user's search context may be formed through a plurality of search context factors. Each of the search context factors may be inferred or determined from at least one of the user input or the context information. The at least one processor 120 may determine a plurality of search context factors that form the user's search context, based on at least one of a keyword extracted from the user input, a meaning inferred from the user input, or a constraint related to the search and at least one of information about the user, time information, location information, or sensing information obtained by the user device, which is obtained as context information.

The at least one processor 120 may be configured to execute the at least one instruction to determine, from the determined user's search context, a tolerance limit representing a degree to which the user is tolerable. The tolerance limit is a certain indicator for a search. As the tolerance limit is lower, faster and more immediate search results are provided. As the tolerance limit is higher, more search results are provided although it takes time. The tolerance limit may vary depending on the user's search context. The tolerance limit may be determined based on a plurality of tolerance limit elements.

According to an embodiment of the disclosure, the at least one processor 120 may obtain a tolerance limit based on a plurality of tolerance limit elements corresponding to a plurality of search context factors. The at least one processor 120 may determine a tolerance limit element corresponding to each search context factor with respect to each search context factor, and may determine a tolerance limit based on all determined tolerance limit elements.

According to an embodiment of the disclosure, when a first search context factor is present, the at least one processor 120 may determine a first tolerance limit element corresponding to the first search context factor. The at least one processor 120 may determine a lower or higher value for the first tolerance limit element according to the first search context factor. When a second search context factor is present, the at least one processor 120 may determine a second tolerance limit element corresponding to the second search context factor. The at least one processor 120 may determine a lower or higher value for the second tolerance limit element according to the second search context factor. In this manner, the at least one processor 120 may determine an M^{th} tolerance limit factor corresponding to an M^{th} search context factor. The at least one processor 120 may determine a lower or higher value for the M^{th} tolerance limit element according to the M^{th} search context factor.

According to an embodiment of the disclosure, the at least one processor 120 may obtain a tolerance limit according to an output value of a certain function or a certain learning model, which receives at least one of a plurality of tolerance limit elements as input. The certain function may be a function that outputs a certain value through a certain operation among the values of the tolerance limit elements or selects a certain value in accordance with a certain rule among the values of the tolerance limit elements. Alternatively, the certain function may be a function that calculates a mean, such as an arithmetic mean, a harmonic mean, a geometric mean, or a weighted mean of the values of the tolerance limit elements, or outputs a minimum or maximum value among the values of the tolerance limit elements. Alternatively, the certain function may be a function that receives at least one of the values of the tolerance limit elements as input and outputs a certain operation result. The certain learning model may be a tolerance limit determination model in the form of a deep learning model or a machine learning model, which receives at least one of the values of the tolerance limit elements as input.

According to an embodiment of the disclosure, when the at least one processor 120 is unable to determine a tolerance limit element corresponding to some search context factors, the at least one processor 120 may obtain a tolerance limit based on the determined tolerance limit elements, or obtain a tolerance limit by applying a default value to the tolerance limit elements that are not determined. When the values of all tolerance limit elements are not determined, the at least one processor 120 may determine a certain predefined value as the tolerance limit.

The at least one processor 120 may be configured to execute the at least one instruction to obtain a search condition for a search, based on the determined tolerance limit. The search condition refers to a condition that may qualitatively or quantitatively affect search results when the at least one processor 120 performs a search.

According to an embodiment of the disclosure, the search condition may be a query condition used in a query generated by the at least one processor 120 to correspond to the user input for a search. The at least one processor 120 may obtain a query condition that affects a search time, based on the determined tolerance limit. The at least one processor 120 may adaptively change the query condition based on the determined tolerance limit. The query condition that affects the search time may be based on at least one of a search scope in a user's personal knowledge graph or a limitation on knowledge property information of each node in a personal knowledge graph. The search scope in the personal knowledge graph may include at least one of the number of nodes to be searched for among nodes constituting the personal knowledge graph or the level of the node in the personal knowledge graph. For example, the at least one processor 120 may adjust the number of nodes to be searched for or limit a search target to a node of a specific level, according to the tolerance limit. The limitation on the knowledge property information of each node of the personal knowledge graph may include the specification of at least one knowledge property information in a list of knowledge property information defined for the class of each node. For example, the at least one processor 120 may limit the search target to nodes where a value of certain knowledge property information is a specific value, according to the tolerance limit.

According to an embodiment of the disclosure, the search condition may be a search environment condition including allocation of hardware resources of the user device 100 which are used for a search. Limited hardware resources, such as a processing operation module or memory, which are used to perform a search, may be mounted on the user device 100. Therefore, for efficient use of the hardware resources, the at least one processor 120 may obtain a search environment condition including allocation of the hardware resources of the user device 100 used for a search, based on the determined tolerance limit. The at least one processor 120 may flexibly and dynamically change the search environment condition based on the determined tolerance limit. The at least one processor 120 may allocate more processing operation modules and/or memories as the value of the tolerance limit decreases, and the at least one processor 120 may allocate fewer processing operation modules and/or memories as the value of the tolerance limit increases.

The at least one processor 120 may be configured to execute the at least one instruction to provide search results according to the obtained search condition. According to an embodiment of the disclosure, the at least one processor 120 may perform a search according to the obtained search condition. For example, the at least one processor 120 may perform a search according to the obtained query condition. The at least one processor 120 may perform a search in the obtained search environment condition. The at least one processor may perform a search according to the obtained query condition and the obtained search environment condition. After the at least one processor 120 performs a search, the at least one processor 120 may provide search results to the user.

According to an embodiment of the disclosure, the at least one processor 120 may perform a search according to the search condition. The at least one processor 120 may perform filtering from a node searched in a personal knowledge graph to a hop node at a certain distance, or extract search results according to a user's usage pattern or preference. The at least one processor 120 may perform clustering on the search results with respect to each of knowledge property types. The at least one processor 120 may identify the knowledge property information of all nodes included in the search results and cluster the search results for each type.

According to an embodiment of the disclosure, the at least one processor 120 may extract a certain number of top knowledge property information categories for each clustered knowledge property type. The at least one processor 120 may perform N categorizations based on the knowledge property information of instances for each clustered knowledge property type, and then extract the top K knowledge property information categories so as to obtain the highest information gain (wherein N is greater than or equal to K). The at least one processor 120 may categorize the knowledge property information of each instance into N pieces of representative knowledge property information. The at least one processor 120 may categorize instances of clustered knowledge property types into N representative knowledge property information. Thereafter, the at least one processor 120 may extract the top K knowledge property information categories based on the relevance to the search term, knowledge property ranking, etc.

According to an embodiment of the disclosure, the at least one processor 120 may provide a certain number of top knowledge property information categories for each knowledge property type and additional information for each knowledge property information category. The additional information for each knowledge property information category may be the number of instances belonging to the corresponding category.

Embodiments of the disclosure may be implemented in the form of a computer-readable recording medium including computer-executable instructions, such as program modules executable by a computer. A computer-readable recording medium may be any available media that are accessible by the computer and may include any volatile and non-volatile media and any removable and non-removable media. In addition, the computer-readable recording medium may include a computer storage medium and a communication medium. The computer storage medium may include any volatile, non-volatile, removable, and non-removable media that are implemented in any method or technology for storage of information, such as computer-readable instructions, data structures, program modules, or other data. The communication medium may typically include computer-readable instructions, data structures, or other data of a modulated data signal, such as program modules.

Also, the computer-readable recording medium may be provided in the form of a non-transitory computer-readable recording medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

The method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

According to an embodiment of the disclosure, a computer-readable recording medium having recorded thereon a program for causing a computer to perform a method of constructing a personal knowledge graph in a user device, a method of providing a service by using a personal knowledge graph, or a method of providing search results based on a user's search context is provided.

According to an embodiment of the disclosure, a method of providing search results based on a user's search context is provided. The method may include determining a user's search context based on a user input for a search and context information in operation S710. In addition, the method may include determining a tolerance limit representing a degree to which the user is tolerable from the determined user's search context in operation S720. In addition, the method may include obtaining a search condition for the search, based on the determined tolerance limit in operation S730. In addition, the method may include providing search results according to the obtained search condition in operation S740.

In addition, according to an embodiment of the disclosure, the determining of the user's search context in operation S710 may include determining a plurality of search context factors, which form the user's search context, from the user input and the context information. In addition, the determining of the tolerance limit in operation S720 may include obtaining the tolerance limit based on a plurality of tolerance limit elements corresponding to the plurality of determined search context factors.

In addition, the determining of the user's search context in operation S710 may include determining the plurality of search context factors based on at least one of a keyword extracted from the user input, a meaning inferred from the user input, or a constraint related to the search and at least one of information about the user, time information, location information, or sensing information obtained by a user device 100, which is obtained as the context information.

In addition, the determining of the tolerance limit in operation S720 may include obtaining the tolerance limit according to an output value of a certain function or a certain learning model, which receives at least one of the plurality of tolerance limit elements as input.

In addition, according to an embodiment of the disclosure, the obtaining of the search condition in operation S730 may include obtaining a query condition that affects a search time, based on the determined tolerance limit. In addition, the providing of the search results in operation S740 may include performing the search according to the query condition.

In addition, the query condition that affects the search time may be based on at least one of a search scope in a user's personal knowledge graph or a limitation on knowledge property information of each node in a personal knowledge graph.

In addition, the search scope may include at least one of the number of nodes to be searched for among nodes constituting the personal knowledge graph or the level of the node in the personal knowledge graph. The limitation on the knowledge property information of each node may include the specification of at least one knowledge property information in a list of knowledge property information defined for the class of each node.

In addition, the obtaining of the search condition in operation S730 may include obtaining a search environment condition including allocation of hardware resources of the user device 100 used for the search, based on the determined tolerance limit. The providing of the search results in operation S740 may include performing the search in the search environment condition.

In addition, according to an embodiment of the disclosure, the providing of the search results in operation S740 may include performing clustering on the search results according to the search condition with respect to each of knowledge property types in operations S1110 and S1120. In addition, the providing of the search results in operation S740 may include providing a certain number of top knowledge property information categories and additional information for each knowledge property information category with respect to each of the clustered knowledge property types in operations S1130 and S1140.

In addition, according to an embodiment of the disclosure, a computer-readable recording medium having recorded thereon a program for causing a computer to perform the method of providing search results based on a user's search context is provided.

According to an embodiment of the disclosure, a user device for providing search results based on a user's search context is provided. The user device 100 may include memory 110 including one or more storage media storing at least one instruction and at least one processor 120 including a processing circuit. In addition, the at least one processor 120 may be configured to execute the at least one instruction to determine a user's search context based on a user input for a search and context information. In addition, the at least one processor 120 may be configured to execute the at least one instruction to determine, from the determined user's search context, a tolerance limit representing a degree to which the user is tolerable. In addition, the at least one processor 120 may be configured to execute the at least one instruction to obtain a search condition for the search, based on the determined tolerance limit. In addition, the at least one processor 120 may be configured to execute the at least one instruction to provide search results according to the obtained search condition.

In addition, according to an embodiment of the disclosure, the at least one processor 120 may be configured to execute the at least one instruction to determine a plurality of search context factors, which form the user's search context, from the user input and the context information. In addition, the at least one processor 120 may be configured to execute the at least one instruction to obtain the tolerance limit based on a plurality of tolerance limit elements corresponding to the plurality of determined search context factors.

In addition, the at least one processor 120 may be configured to execute the at least one instruction to determine the plurality of search context factors based on at least one of a keyword extracted from the user input, a meaning inferred from the user input, or a constraint related to the search and at least one of information about the user, time information, location information, or sensing information obtained by a user device 100, which is obtained as the context information.

In addition, the at least one processor 120 may be configured to execute the at least one instruction to obtain the tolerance limit according to an output value of a certain function or a certain learning model, which receives at least one of the plurality of tolerance limit elements as input.

In addition, according to an embodiment of the disclosure, the at least one processor 120 may be configured to execute the at least one instruction to obtain a query condition that affects a search time, based on the determined tolerance limit, and perform a search according to the query condition.

In addition, the query condition that affects the search time may be based on at least one of a search scope in a user's personal knowledge graph or a limitation on knowledge property information of each node in a personal knowledge graph.

In addition, the search scope may include at least one of the number of nodes to be searched for among nodes constituting the personal knowledge graph or the level of the node in the personal knowledge graph. In addition, the limitation on the knowledge property information of each node may include the specification of at least one knowledge property information in a list of knowledge property information defined for the class of each node.

In addition, the at least one processor 120 may be configured to execute the at least one instruction to obtain a search environment condition including allocation of hardware resources of the user device 100 used for the search, based on the determined tolerance limit, and perform the search in the search environment condition.

In addition, according to an embodiment of the disclosure, the at least one processor 120 may be configured to execute the at least one instruction to perform clustering on the search results according to the search condition with respect to each of knowledge property types. In addition, the at least one processor 120 may be configured to execute the at least one instruction to provide a certain number of top knowledge property information categories and additional information for each knowledge property information category with respect to each of the clustered knowledge property types.

In an embodiment of the disclosure, the search may be a search utilized in a personalized AI service using a personal knowledge graph.

The foregoing description of the disclosure is for illustrative purposes only, and those of ordinary skill in the art to which the disclosure pertains will understand that modifications into other specific forms may be made thereto without changing the technical spirit or essential features of the disclosure. Therefore, it should be understood that the embodiments of the disclosure described above are illustrative in all aspects and are not restrictive. For example, the components described as being singular may be implemented in a distributed manner. Similarly, the components described as being distributed may be implemented in a combined form.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of providing search results based on a user's search context, the method comprising:
determining a user's search context based on a user input for a search and context information;
determining a tolerance limit representing a degree to which a user is tolerable from the determined user's search context;
obtaining a search condition for the search, based on the determined tolerance limit; and
providing search results according to the obtained search condition.

2. The method of claim 1,
wherein the determining of the user's search context comprises determining a plurality of search context factors, which form the user's search context, from the user input and the context information, and
wherein the determining of the tolerance limit comprises obtaining the tolerance limit based on a plurality of tolerance limit elements corresponding to the plurality of search context factors.

3. The method of claim 2, wherein the determining of the user's search context comprises determining the plurality of search context factors based on at least one of a keyword extracted from the user input, a meaning inferred from the user input, or a constraint related to the search and at least one of information about the user, time information, location information, or sensing information obtained by a user device, which is obtained as the context information.

4. The method of claim 2, wherein the determining of the tolerance limit comprises obtaining the tolerance limit according to an output value of a certain function or a certain learning model, which receives at least one of the plurality of tolerance limit elements as input.

5. The method of claim 1,
wherein the obtaining of the search condition comprises obtaining a query condition that affects a search time, based on the determined tolerance limit, and
wherein the providing of the search results comprises performing the search according to the query condition.

6. The method of claim 5, wherein the query condition that affects the search time is based on at least one of a search scope in a personal knowledge graph of the user or a limitation on knowledge property information of each node in the personal knowledge graph.

7. The method of claim 6,
wherein the search scope comprises at least one of a number of nodes to be searched for among nodes constituting the personal knowledge graph or a level of a node in the personal knowledge graph, and
wherein the limitation on the knowledge property information of each node comprises a specification of at least one knowledge property information in a list of knowledge property information defined for a class of each node.

8. The method of claim 5,
wherein the obtaining of the search condition comprises obtaining a search environment condition including allocation of hardware resources of a user device used for the search, based on the determined tolerance limit, and
wherein the providing of the search results comprises performing the search in the search environment condition.

9. The method of claim 1, wherein the providing of the search results comprises:
performing clustering on the search results according to the search condition with respect to each of knowledge property types; and
providing a certain number of top knowledge property information categories and additional information for each knowledge property information category with respect to each of the clustered knowledge property types.

10. One or more non-transitory computer-readable storage media storing one or more computer programs including computer-executable instructions that, when executed by one or more processors of an electronic device individually or collectively, cause the electronic device to perform operations, the operations comprising:
determining a user's search context based on a user input for a search and context information;
determining a tolerance limit representing a degree to which a user is tolerable from the determined user's search context;
obtaining a search condition for the search, based on the determined tolerance limit; and
providing search results according to the obtained search condition.

11. A user device comprising:
memory, comprising one or more storage media, storing one or more computer programs; and
one or more processors communicatively coupled to the memory,
wherein the one or more computer programs include computer-executable instructions that, when executed by the one or more processors individually or collectively, cause the user device to:
determine a user's search context based on a user input for a search and context information,
determine a tolerance limit representing a degree to which a user is tolerable from the determined user's search context,
obtain a search condition for the search, based on the determined tolerance limit, and
provide search results according to the obtained search condition.

12. The user device of claim 11, wherein the one or more computer programs further include computer-executable instructions that, when executed by the one or more processors individually or collectively, cause the user device to:
determine a plurality of search context factors, which form the user's search context, from the user input and the context information; and
obtain the tolerance limit based on a plurality of tolerance limit elements corresponding to the plurality of determined search context factors.

13. The user device of claim 12, wherein the one or more computer programs further include computer-executable instructions that, when executed by the one or more processors individually or collectively, cause the user device to determine the plurality of search context factors based on at least one of a keyword extracted from the user input, a meaning inferred from the user input, or a constraint related to the search and at least one of information about the user, time information, location information, or sensing information obtained by a user device, which is obtained as the context information.

14. The user device of claim 12, wherein the one or more computer programs further include computer-executable instructions that, when executed by the one or more processors individually or collectively, cause the user device to obtain the tolerance limit according to an output value of a certain function or a certain learning model, which receives at least one of the plurality of tolerance limit elements as input.

15. The user device of claim 11, wherein the one or more computer programs further include computer-executable instructions that, when executed by the one or more processors individually or collectively, cause the user device to:
obtain a query condition that affects a search time, based on the determined tolerance limit; and
perform the search according to the query condition.

16. The user device of claim 15, wherein the query condition that affects the search time is based on at least one of a search scope in a personal knowledge graph of the user or a limitation on knowledge property information of each node in the personal knowledge graph.

17. The user device of claim 16,
wherein the search scope comprises at least one of a number of nodes to be searched for among nodes constituting the personal knowledge graph or a level of a node in the personal knowledge graph, and
wherein the limitation on the knowledge property information of each node comprises a specification of at least one knowledge property information in a list of knowledge property information defined for a class of each node.

18. The user device of claim 15, wherein the at one or more computer programs further include computer-executable instructions that, when executed by the one or more processors individually or collectively, cause the user device to:
obtain a search environment condition including allocation of hardware resources of the user device used for the search, based on the determined tolerance limit; and
perform the search in the search environment condition.

19. The user device of claim 11, wherein the one or more computer programs further include computer-executable instructions that, when executed by the one or more processors individually or collectively, cause the user device to:
perform clustering on the search results according to the search condition with respect to each of knowledge property types; and
provide a certain number of top knowledge property information categories and additional information for each knowledge property information category with respect to each of the clustered knowledge property types.

20. The user device of claim 11, wherein the search comprises a search utilized in a personalized artificial intelligence (AI) service using a personal knowledge graph.
